(19) United States
(12) Patent Application Publication
(10) Pub. No.: US 2021/0118271 A1
(43) Pub. Date: Apr. 22, 2021

(54) EQUIPMENT USAGE STATUS PUBLICATION SYSTEM, EQUIPMENT USAGE STATUS PUBLICATION METHOD, AND PROGRAM

(71) Applicant: SHIMIZU CORPORATION, Chuo-ku, Tokyo (JP)

(72) Inventor: Takashi MATSUMOTO, Chuo-ku, Tokyo (JP)

(73) Assignee: SHIMIZU CORPORATION, Chuo-ku, Tokyo (JP)

(21) Appl. No.: 17/055,202

(22) PCT Filed: Feb. 25, 2019
(86) PCT No.: PCT/JP2019/007143

§ 371 Date: Nov. 13, 2020

(30) Foreign Application Priority Data
May 24, 2018 (JP) 2018-099836

(51) Int. Cl. G08B 5/22; E03D 11/00; H04W 4/33

(52) U.S. Cl. CPC G08B 5/221; H04W 4/33; E03D 11/00

(57) ABSTRACT

An equipment usage status publication system, has a storage unit configured to store information indicating a plurality of equipment, each of the plurality of equipment having one or more than one detection unit for detecting a usage status, information indicating each of a plurality of zones where the plurality of equipment are disposed respectively, information indicating each area to which each of the plurality of zones belongs, and information indicating an access permission for a user; a setting unit configured to set a publication level with respect to each area; and a provision unit configured to provide information indicating the usage status of each of the plurality of equipment to a terminal of each user, the information indicating the usage status corresponding to the detection result of the detection unit and according to the publication level and the access permission.

### TECHNICAL FIELD

The present disclosure relates to an equipment usage status publication system, an equipment usage status publication method, and a program.

Priority is claimed on a Japanese Patent Application No. 2018-099836, filed on May 24, 2018, whose content is incorporated herein for reference.

### BACKGROUND ART

In Patent Documents 1-3, due to informatization of toilet, systems configured to notify availability information of a toilet, information for maintenance and the like are disclosed. According to a toilet availability display equipment disclosed in Patent Document 1, a toilet usage status is notified to an aggregation means, and a result of congestion degree of each toilet calculated by the aggregation means is displayed together with map information of a toilet by a display means.

According to a toilet usage status display equipment disclosed in Patent Document 2, data of a sitting sensor of a toilet equipment is transmitted to a central management equipment via a network, and a usage status of a toilet booth acquired by detecting whether a user of the toilet booth exists is displayed on a display equipment.

According to a toilet information system disclosed in Patent Document 3, toilet information collected from a sensor disposed in each toilet is stored in a plurality of storage devices that are disposed to be distributed in a communication network. The toilet information system disclosed in Patent Document 3 collects and is configured to display the toilet information at a suitable timing, and in response to a request of a user terminal, the toilet information system acquires information included in the toilet information and corresponding to the request of the user terminal and provides the information to the user terminal.

### CITATION LIST

### Patent Documents

[Patent Document 1] Japanese Unexamined Patent Application, First Publication No. H6-333174

[Patent Document 2] Japanese Unexamined Patent Application, First Publication No. 2002-21149

[Patent Document 3] Japanese Unexamined Patent Application, First Publication No. 2016-204833

### SUMMARY OF INVENTION

### Technical Problem

In a situation of publicating a usage status of a toilet, a following application scenario is considered. For example, in a situation of limiting a usage of a specific facility in a complex facility and the like to a registered user, a usage status of a toilet in the specific facility is only publicated to the registered user and the usage status is not publicated to a general user that is not registered. However, the systems disclosed in Patent Documents 1-3 are made without taking the situation of limiting the publication targets in consideration and cannot respond to such application scenario.

The present disclosure has been made in view of the above circumstances and an object of the present disclosure is to provide an equipment usage status publication system, an equipment usage status publication method, and a program so as to provide information indicating a usage status of equipment such as a toilet and the like by limiting a publication target of the information corresponding to a user.

### Solution to Problem

According to an aspect of the present disclosure, an equipment usage status publication system has a storage unit configured to store information indicating a plurality of equipment, each of the plurality of equipment having one or more than one detection units for detecting a usage status, information indicating a plurality of zones where the plurality of equipment are disposed respectively, information indicating each area to which each of the plurality of zones belongs, and information indicating an access permission for a user; a setting unit configured to set a publication level with respect to each area; and a provision unit configured to provide information indicating the usage status of each of the plurality of equipment to a terminal of each user, the information indicating the usage status corresponding to the detection result of the detection unit and according to the publication level and the access permission.

According to an aspect of the present disclosure, an equipment usage status publication method has, storing information indicating a plurality of equipment, each of the plurality of equipment having one or more than one detection units for detecting a usage status, information indicating each of a plurality of zones where the plurality of equipment are disposed respectively, information indicating each area to which each of the plurality of zones belongs, and information indicating an access permission for a user, by a storage unit; setting a publication level with respect to each area by a setting unit; and providing information indicating the usage status of each of the plurality of equipment to a terminal of each user, the information indicating the usage status corresponding to the detection result of the detection unit and according to the publication level and the access permission by a provision unit.

According to an aspect of the present disclosure, a program is provided to make a computer to execute a method of storing information indicating a plurality of equipment, each of the plurality of equipment having one or more than one detection units for detecting a usage status, information indicating each of a plurality of zones where the plurality of equipment are disposed respectively, information indicating each area to which each of the plurality of zones belongs, and information indicating an access permission for a user, by a storage unit; setting a publication level with respect to each area by a setting unit; and providing information indicating the usage status of each of the plurality of equipment to a terminal of each user, the information indicating the usage status corresponding to the detection result of the detection unit and according to the publication level and the access permission by a provision unit.

### Advantageous Effects of Invention

According to the aspects described above, the equipment usage status publication system, the equipment usage status publication method, and the program can provide information indicating the usage status of the equipment such as the toilet and the like by limiting the publication target of the information corresponding to the user.

### BRIEF DESCRIPTION OF DRAWINGS

FIG. 1 is a block diagram showing a configuration example of an equipment usage status publication system according to an embodiment of the present disclosure.

FIG. 2 is a schematic view showing a configuration example of an equipment-zone correspondence file 11 shown in FIG. 1.

FIG. 3 is a schematic view showing a configuration example of a zone-area correspondence file 12 shown in FIG. 1.

FIG. 4 is a schematic view showing a configuration example of a publication level setting file 13 shown in FIG. 1.

FIG. 5 is a schematic view showing a configuration example of a user access permission setting file 14 shown in FIG. 1.

FIG. 6 is a schematic view showing a configuration example of the user access permission setting file 14 shown in FIG. 1.

FIG. 7 is a schematic view showing a configuration example of an equipment usage status file 15 shown in FIG. 1.

FIG. 8 is a flowchart showing an operation example of a provision unit 4 shown in FIG. 1.

FIG. 9 is a schematic view showing a display example of a display unit 32 shown in FIG. 1.

### DESCRIPTION OF EMBODIMENTS

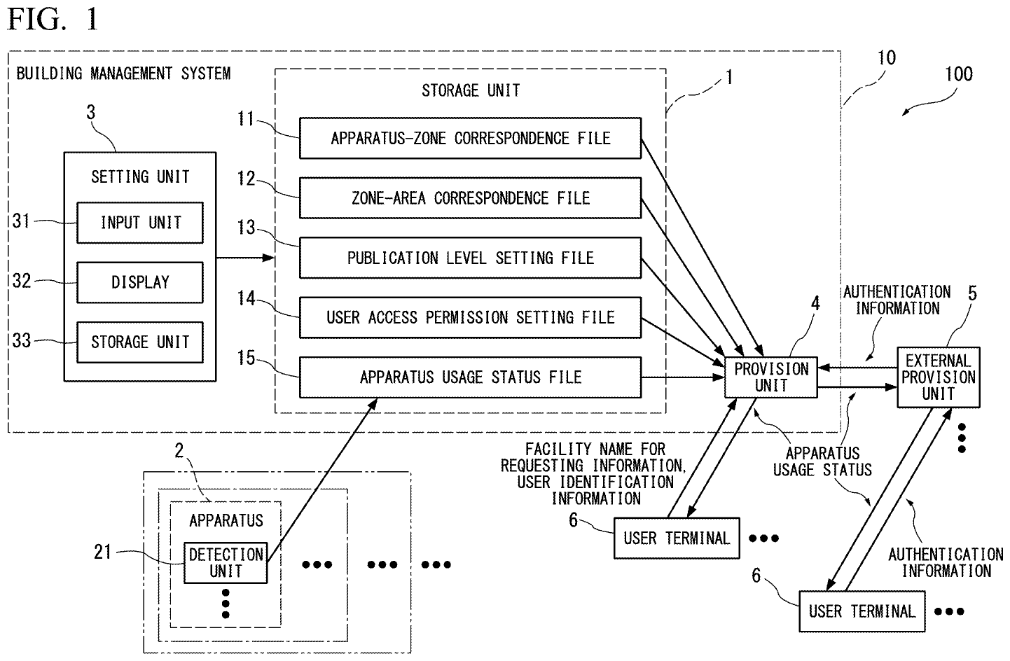

An embodiment of the present disclosure will be described referring to figures. FIG. 1 is a block diagram showing a configuration example of an equipment usage status publication system 100 according to an embodiment of the present disclosure. The equipment usage status publication system 100 has a building management system 10, a plurality of equipment 2, a plurality of external provision units 5, and a plurality of user terminals 6. The building management system 10 has a storage unit 1, a setting unit 3, and a provision unit 4.

The storage unit 1 has a storage device, a communication device, a control device (one or a plurality of computers), and the like. The storage unit 1 is configured to store a plurality of files including an equipment-zone correspondence file 11, a zone-area correspondence file 12, a publication level setting file 13, a user access permission setting file 14, and an equipment usage status file 15. The storage unit 1 is configured to store and update specific data transmitted from each of the plurality of equipment 2 via a communication network that is not shown in the figures.

The plurality of equipment 2 are equipment such as toilets and the like inside a building, and the plurality of equipment 2 have one or a plurality of detection units 21 configured to acquire an in-use state or a non-use state. The detection unit 21 is configured to notify the storage unit 1 via the communication network with a detection result indicating the in-use state and the non-use state. For example, in a case in which the equipment 2 is an apparatus inside a toilet, human sensors and the like are disposed as the detection unit 21 at urinals, washing stands, passageways, and the like besides in each private room so as to detect a usage status of each equipment. However, in consideration of protecting an individual privacy of the user, it is preferable for the detection unit 21 to output a binary signal indicating the in-use state and the non-use state. For example, the detection unit 21 disposed in the passageway may be used to detect a queue in a rush hour. Each detection unit 21 is connected to the communication network through a wireless network or a wired network, and each detection unit 21 notifies the building management system 10 with the detection result indicating the usage status almost in real time. The equipment 2 is not limited to the toilet, for example, the equipment 2 may be a shared equipment or partially shared equipment in the building such as a coin locker, a waiting bench, a shared office, a parking space or the like.

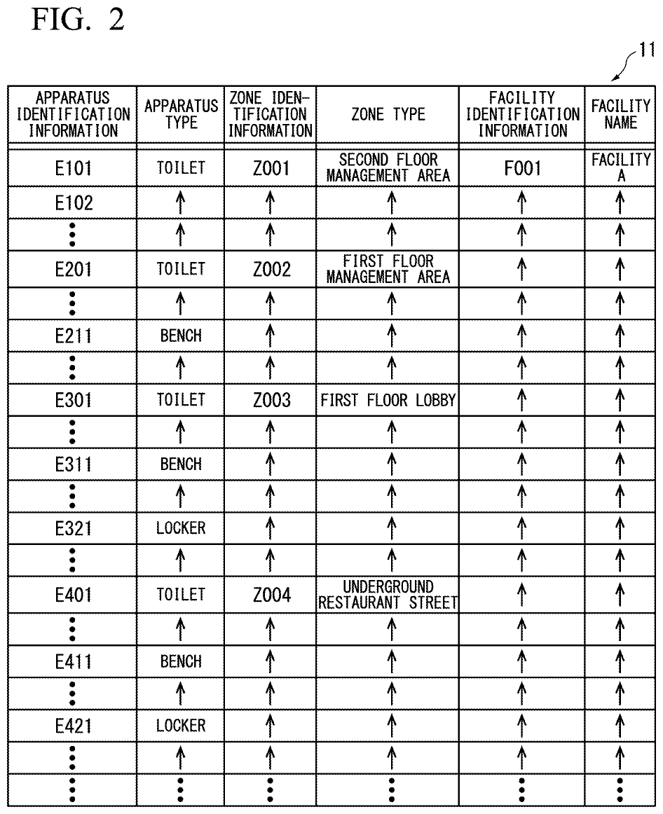

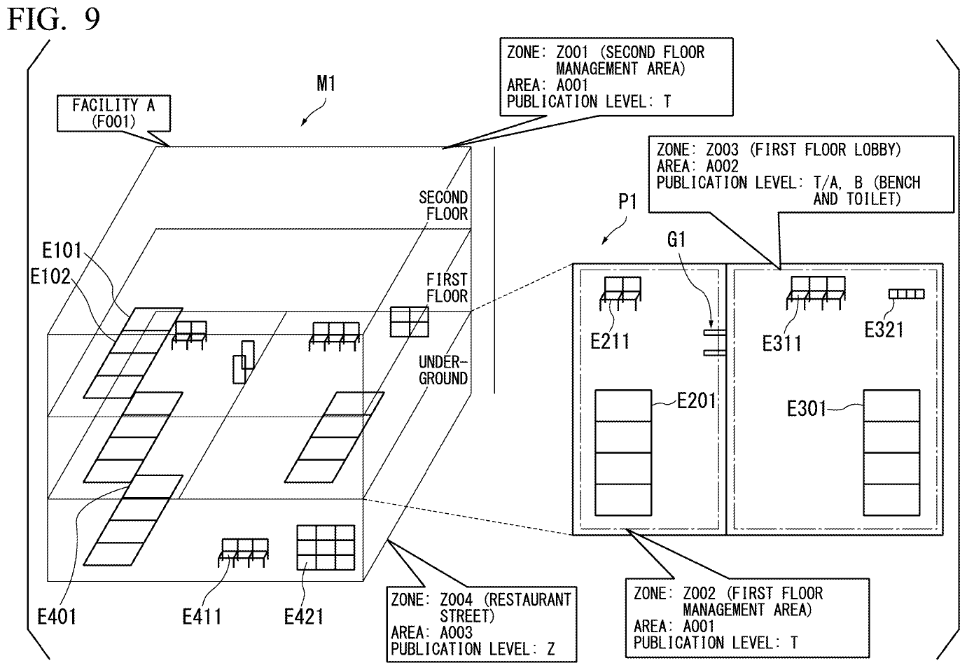

Configuration examples of the equipment-zone correspondence file 11, the zone-area correspondence file 12, the publication level setting file 13, the user access permission setting file 14, and the equipment usage status file 15 stored by the storage unit 1 will be described referring to FIGS. 2 to 7. FIGS. 2 to 7 show configuration examples of each of the plurality of files 11-15 by taking a facility shown in FIG. 9 as an example. FIG. 9 is a schematic view showing a display example of the display unit 32 shown in FIG. 1, and FIG. 9 has a three-dimensional model image M1 indicating a facility A being a building having two floors above ground and one floor under ground and a floor map P1 of the second floor. In the facility A, the second floor (zone Z001) is a management area such as offices and the like, and the second floor is used by registered users only. The first floor of the facility A has a lobby (zone Z003), and a management area (zone Z002) which is used by registered users only. The underground floor (zone Z004) of the facility A is a restaurant street and is used for general uses that are not registered.

According to the present embodiment, a space where people can enter and exit and a space where people cannot enter and exit are distinguished and defined separately in the floor map P1 and the like, and a minimum unit of the space where people can enter and exit is defined as a “zone”. As a basic principle, the zone is defined as a place for restricting the entrance and exit such as a door, a building gate and the like. Hereinafter, the place for restricting the entrance and exit is disclosed as a “gate”. In the example shown in FIG. 9, in the first floor, the zone Z002 and the zone Z003 is partitioned by a gate Gl.

As shown in FIG. 9, for example, four toilet private rooms E101, E102, corresponding to the equipment 2 shown in FIG. 1 are provided on the second floor (zone Z001). For example, four toilet private rooms E201, . . . and two benches E211, corresponding to the equipment 2 shown in FIG. 1 are provided in the management zoon (zone Z002) on the first floor. For example, four toilet private rooms E301, . . . , three benches E311, . . . , and four lockers E321, . . . corresponding to the equipment 2 shown in FIG. 1 are provided in the lobby (zone Z003) on the first floor. For example, four toilet private rooms E401, . . . , three benches E411, . . . , and nine lockers E421, corresponding to the equipment 2 shown in FIG. 1 are provided underground (zone Z004).

According to the present embodiment, the adjacent zones where restrictions on entrance and exit of people are the same are supposed to be the same area. However, the area may be divided in consideration of management. An open degree of an access permission for a user to enter an area (hereinafter disclosed as user access permission) is referred to a publication level (security level). In other words, according to the present embodiment, the publication level of the usage status for each equipment 2 is set by each area. The area and the zone may be the same partition, and the area may include a plurality of zones which are adjacent to each other or separated from each other.

According to the present embodiment, the publication level is set to have four variations such as “T”, “A”, “B” and “Z”. Either of the publication level “T”, “A”, “B” and “Z” is set with respect to each user (or each user group consisted from a plurality of users). The usage status of each equipment 2 whose publication level is set to “A” is published to the user (or user group) whose user access permission is “A”. The usage status of each equipment 2 whose publication level is set to “B” is published to the user (or user group) whose user access permission is “B”. Regardless of the user access permission, the usage status of each equipment 2 whose publication level is set to “Z” is published to all of the users (and user groups). Multiple publication levels may be set to each equipment 2. For example, the usage state of each equipment 2 whose publication level is set to both of “T” and “A” is published to the user (or user group) whose user access permission is “T” and the user (or user group) whose user access permission is “A”. Hereinafter, there may be a case in which only the term “user” is used and the term “user group” is omitted.

In the example shown in FIG. 9, the zone Z001 and the zone Z002 belong to the area A001. The publication level of the area A001 is “T”. In this case, the usage status of the four toilet private rooms E101, E102, . . . in the area A001 are published to the user whose access permission is set to “T”. On the other hand, the usage status of each equipment 2 in the area A001 is not published to the user whose access permission is set to “B” or “Z”.

The zone Z003 belongs to the area A002. The publication level of the area A002 is “T”, or “A” or “B”. Here, the publication level of the lockers E321, . . . is “T” only, and the publication level of the four private rooms E301, . . . and three benches E311, . . . is “T” or “A” or “B”. In this case, the usage status of the four private rooms E301, . . . , the three benches E311, . . . , and the four lockers E321, . . . in the area A002 is published to the user having the user access permission of “T”. On the other hand, with respect to the user having the user access permission of “A” or “B”, the usage status of the four private rooms E301, . . . , and the three benches E311, . . . , is published to the user, and the usage status of the four lockers E321, . . . is not published. The usage status of each equipment 2 in the area A002 is not published to the user having the user access permission “Z”.

The zone Z004 belongs to the area A003. The publication level of the area A003 is set to be “Z”. In this case, despite of the user access permission, the usage status of each equipment 2 in the area A003 is published to all of the users.

As described above, according to the present embodiment, in the case in which the user access permission is set to “T”, the corresponding user is permitted to access information indicating the usage status of each equipment 2 whose publication level is set to “T” or “Z”. In the case in which the user access permission is set to “A”, the corresponding user is permitted to access information indicating the usage status of each equipment 2 whose publication level is set to “A” or “Z”. In the case in which the user access permission is set to “B”, the corresponding user is permitted to access information indicating the usage status of each equipment 2 whose publication level is set to “B” or “Z”. In the case in which the user access permission is set to “Z”, the corresponding user is permitted to access information indicating the usage status of each equipment 2 whose publication level is set to “Z”.

According to the present embodiment, the publication level is not limited to four variations and the publication level may be set to multiple variations equal to two or more than two. In response to the necessity of management, the zone may be divided by the characteristic such as indoor or outdoor. The gate may be connected to the building management system through the network so as to be able to remotely open and close the lock and assign and change the open-close authority of the user holding an Integrated Circuit (IC).

FIG. 2 is a schematic view showing a configuration example of the equipment-zone correspondence file 11 shown in FIG. 1. The equipment-zone correspondence file 11 includes data indicating the correspondence between each equipment 2 shown in FIG. 1 and each zone where the equipment is disposed. The equipment-zone correspondence file 11 shown in FIG. 2 includes data generated by associating equipment identification information for identifying the equipment 2 and an equipment type of the equipment 2 by each equipment 2, zone identification information for specifying the zone where the equipment 2 is disposed, a zone type, facility identification information for identifying the facility, and a facility name. For example, the equipment-zone correspondence file 11 includes data indicating that the equipment identification information of the toilet private rooms E101 and E102 provided on the second floor shown in FIG. 2 is “E101” and “E102”, the equipment type is “toilet”, the zone identification information is “Z001”, the zone type is “second floor management zone”, the facility identification information is “F001”, and the facility name is “facility A”. For example, the equipment-zone correspondence file 11 includes data indicating that the equipment identification information of the toilet private room E401 provided underground shown in FIG. 9 is “E401”, the equipment type is “toilet”, the zone identification information is “Z004”, the zone type is “underground restaurant street”, the facility identification information is “F001”, and the facility name is “facility A”.

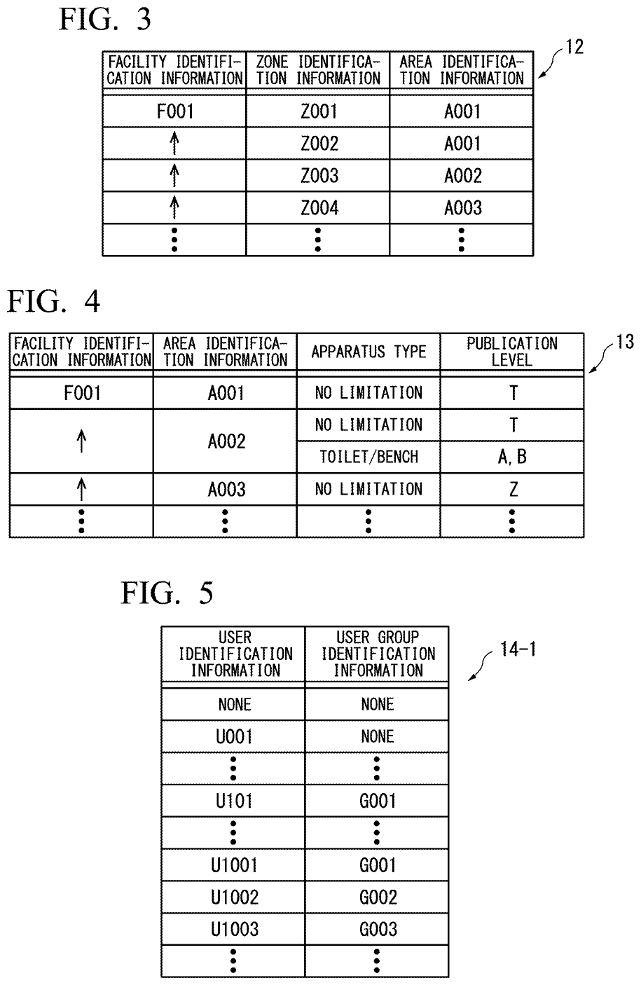

FIG. 3 is a schematic view showing a configuration example of the zone-area correspondence file 12 shown in FIG. 1. The zone-area correspondence file 12 includes data indicating the correspondence between each zone indicated by the data included in the equipment-zone correspondence file 11 shown in FIG. 2 and each area including the zone. In the facility having the facility identification information “F001”, the zone-area correspondence file 12 shown in FIG. 3 includes data indicating that the zone Z001 and the zone Z002 correspond to the area A001 having the area identification information “A001”, the zone Z003 corresponds to the area A002 having the area identification information “A002”, and the zone Z004 corresponds to the area A003 having the area identification information “A004”.

FIG. 4 is a schematic view showing a configuration example of the publication level setting file 13 shown in FIG. 1. The publication level setting file 13 includes data indicating the correspondence between each area identification information indicated by the data included in the zone-area correspondence file 12 shown in FIG. 3 and the setting value of the publication level of each area. The publication level setting file 13 shown in FIG. 4 includes data indicating that in the facility whose facility identification information is “F001” (hereinafter omitted), the publication level of the area A001 whose area identification information is “A001” is set to be “T”, and there is no limitation for the equipment types. The publication level setting file 13 shown in FIG. 4 includes data indicating that the publication level of the area A002 whose area identification information is “A002” is set to be “T”, and there is no limitation for the equipment types. The publication level setting file 13 shown in FIG. 4 includes data indicating that the publication level of the area A002 whose area identification information is “A002” is set to be “A” or “B”, and the equipment types are limited to the “toilet” or “bench”. The publication level setting file 13 includes data indicating that the publication level of the area A003 whose area identification information is “A003” is set to “Z” and there is no limitation for the equipment types.

The publication level may be set to change due to weekdays and holidays, or change due to time periods.

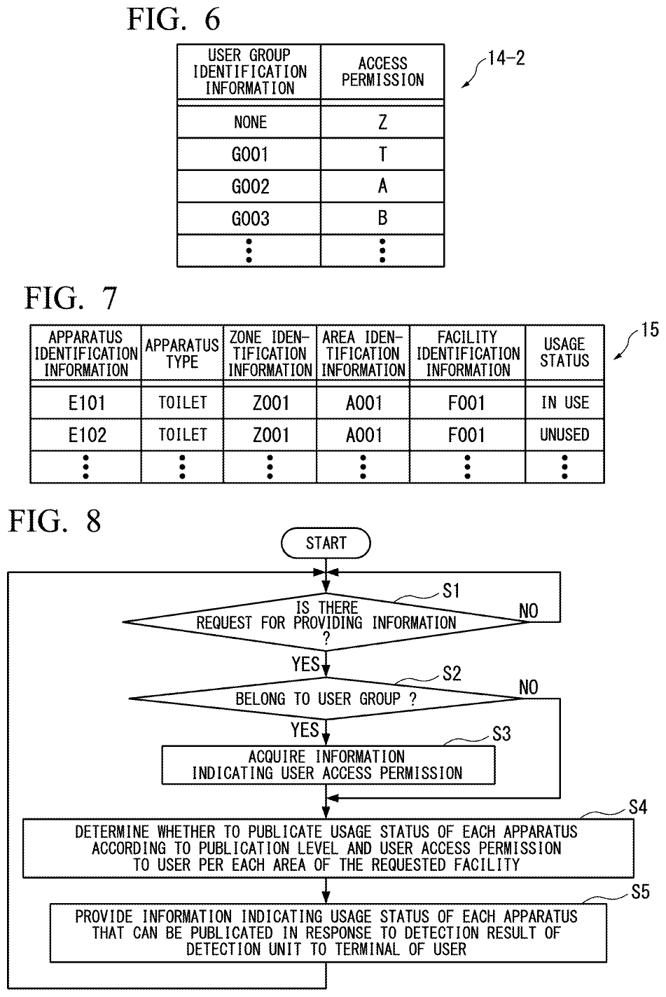

FIGS. 5-6 are schematic views showing configuration examples of the user access permission setting file 14 shown in FIG. 1. The user access permission setting file 14 shown in FIG. 1 includes data indicating the user access permission for each user to access the information indicating the usage status of each equipment 2.

According to the present embodiment, the user access permission is defined by two stages shown below. In other words, the user access permission is defined by a first stage setting to correspond the user and the user group to which the user belongs and a second stage setting to correspond each user group and the user access permission. In other words, the user access permission is defined per the user group by taking a plurality of users as a unit. For example, the user group is formed by each tenant of the building and the user access permission is set by the unit of the user group. It is possible to collectively manage the setting of the user access permission with respect to each staff of the tenant by including the staffs of the tenant in the user group of each tenant. On the other hand, it is possible to form the user group for registered users of a navigation application (navigation service) executed on smart phones or the like and set the user access permission to the user group.

According to the present embodiment, the user access permission setting file 14 shown in FIG. 1 is configured from a pair of a user access setting file 14-1 shown in FIG. 5 and a user access permission setting file 14-2 shown in FIG. 6. The user access setting file 14-1 shown in FIG. 5 includes data corresponding the user identification information for identifying each user and the user group identification information for identifying the user group to which each user belongs. For example, the user identification information is a unique user identification code (ID), a telephone number, a mail address or the like of a user ID or the user terminal 6, wherein the user identification information is set at the time of performing a usage registration to the building management system 10. The user access permission setting file 14-2 shown in FIG. 6 includes data corresponding each user group identification information identified by the data included in the user access permission setting file 14-1 shown in FIG. 5 and the user access permission. In a case in which the user group identification information with respect to the user identification information is not set in the user access permission setting file 14-1, the user access permission for the user identified by the user identification information will be set to be “Z” corresponding to the lowest publication level. The user access permission with respect to the access without providing the user identification information to the provision unit 4 will be set to be “Z” corresponding to the lowest publication level. For example, the access without providing the user identification information to the provision unit 4 refers to the user before creating the account, or a case of an anonymous usage since it is refused to provide the identification information due to opt-out and the like.

In the example shown in FIG. 5 and FIG. 6, for example, since the user identification information in the user group is “none” and the user group identification information of the user group is “none”, the user access permission of the user whose user identification information is “none” is set to be “Z”. Since the user identification information in the user group is “U001” and the user group identification information of the user group is “none”, the user access permission of the user whose user identification information is “U001” is set to be “Z”. Since the user identification information in the user group is “U101” and the user group identification information of the user group is “G001”, the user access permission of the user whose user identification information is “U101” is set to be “T”. Since the user identification information in the user group is “U1001” and the user group identification information of the user group is “G001”, the user access permission of the user whose user identification information is “U1001” is set to be “T”. Since the user identification information in the user group is “U1002” and the user group identification information of the user group is “G002”, the user access permission of the user whose user identification information is “U1002” is set to be “A”.

FIG. 7 is a schematic view showing a configuration example of the equipment usage status file 15 shown in FIG. 1. The equipment usage status file 15 includes data corresponding each equipment 2 and the usage status of each equipment 2. The equipment usage status file 15 shown in FIG. 7 includes data corresponding the equipment identification information, the equipment type for each equipment 2, the zone identification information of the zone where the equipment 2 is disposed, the area identification information of the area including the zone, the facility identification information, and the usage status of the equipment 2. For example, the equipment usage status file 15 includes the data indicating that the usage status of the toilet private room E101 provided on the second floor and having the equipment identification information “E101” as shown in FIG. 9 is “in use”. For example, the equipment usage status file 15 includes the data indicating that the usage status of the toilet private room E102 provided on the second floor and having the equipment identification information “E102” as shown in FIG. 9 is “unused”. The data indicating the “usage status” in the equipment usage status file 15 is frequently updated by the storage unit 1 according to the data indicating the detection result transmitted from the detection unit 21 of the equipment 2. The data indicating the “usage status” is set to one of “in use”, “unused”, and “error”. For example, the data indicating the “usage status” may include data indicating a duration period from the “usage status” being “in use”.

Next, the setting unit 3 shown in FIG. 1 will be described. For example, the setting unit 3 is a terminal such as a computer and the like, and the setting unit 3 has an input unit 31, a display unit 32, and a storage unit 33. The input unit 31 is an input device such as a keyboard, a mouse and the like, and the input unit 31 is configured to receive an input operation by an operator. The display unit 32 is an image display device such as a display panel and the like. The storage unit 33 is a storage device configured to store information for displaying a three-dimensional model image M1 of each facility shown by the display unit 32 and the floor map P1 as shown in FIG. 9, the definition information of the zone in each facility and the like. The setting unit 3 is configured to control the display unit 32 to display an image such as the three-dimensional model image M1 indicating the correspondence relationship of the area and the zone, the floor map P1 and the like, and the setting unit 3 is configured to set the publication level for each area in response to the input operation by the input unit 31 with respect to the image. For example, the setting unit 3 may set the publication level by area in response to operations by the user such as selecting the three-dimensional model image M1 by a pointer and inputting or selecting setting items. For example, the three-dimensional model image M1 may be displayed by a wireframe, by using a photographed image, and by computer graphics (CG). For example, the display unit 32 may not display the three-dimensional model image M1 and display the floor map P1 only. The display unit 32 may visualize and display the area and the zone in a two-dimensional planar form according to the three-dimensional model. The setting unit 3 may set the publication level per area and per type of the equipment. The setting unit 3 may set the correspondence between the area and the zone. The publication level set by the setting unit 3 is stored in the publication level setting file 13 per area and per type of the equipment. The correspondence between the area and the zone which is set by the setting unit 3 is stored in the zone-area correspondence file 12.

The provision unit 4 shown in FIG. 1 is a computer having a storage device, a communication device, and a control device. The provision unit 4 is configured to provide information indicating the usage status of each equipment 2 according to the publication level and the user access permission in response to the detection result of the detection unit 21 and by referring to the equipment-zone correspondence file 11, the zone-area correspondence file 12, the publication level setting file 13, the user access permission setting file 14, and the equipment usage status file 15 that is stored by the storage device 1 to the external provision unit 5 and the user terminal 6 as the terminal of the user.

For example, the external provision unit 5 is a computer having a storage device, a communication device, a control device and the like, and the provision unit 5 is managed by an administrator who makes an information providing contract with the building management system 10 in advance. For example, the external provision unit 5 is administrated by the tenant in the building, the provider of the navigation service and the like. For example, the external provision unit 5 is configured to provide the information received from the provision unit 4 indicating the usage status of each equipment 2 with respect to the user terminal 6 used by the staff of the tenant and the user terminal 6 used by the user of the navigation service. At this time, the external provision unit 5 requests the provision unit 4 to provide information by transmitting the user identification information of the administrator of the external provision unit 5 and authentication information formed from a password registered in advance and the like. For example, the external provision unit 5 obtains the information indicating the usage status of each equipment 2 from the provision unit 4 regularly. For example, the external provision unit 5 provides the information indicating the usage status of each equipment 2 that is provided by the provision unit 4 to the user terminal 6 in response to the information providing request together with the authentication information (user ID, password and the like) from the user terminal 6 used by the previously registered user.

For example, in a case in which the external provision unit 5 is administrated by the tenant on the second floor of the facility A shown in FIG. 9, once the user access permission of the user of the tenant is set to “T” in advance, the external provision unit 5 may obtain the information indicating the usage status of all of the equipment 2 of the facility A shown in FIG. 9 from the provision unit 4. Then, the external provision unit 5 administrated by the tenant may provide the information indicating the usage status of each equipment 2 of the facility A shown in FIG. 9 to the user terminal 6 used by the staff of the tenant, for example. In a case in which the external provision unit 5 is administrated by a company A as the provider of the navigation service, once the user access permission of the user of the company A is set to “A” in advance, the external provision unit 5 may obtain the information indicating the usage status of the equipment 2 of the facility A whose publication level is set to “A” from the provision unit 4. Then, the external provision unit 5 administrated by the company A may provide the information indicating the usage status of the equipment 2 of the facility A whose publication level is set to “A” shown in FIG. 9 to the user terminal 6 used by the user of the navigation service, for example

The user terminal 6 is a computer having a communication function such as a mobile phone, a smartphone, a tablet terminal, a personal computer, a smart speaker and the like. The user terminal 6 is configured to obtain the information indicating the usage status of each equipment 2 of a specified facility and a surrounding facility of the user terminal 6 from the provision unit 4 and the external provision unit 5 and output the obtained information by displaying an image or outputting voice. At this time, for example, the user terminal 6 requests the information providing by transmitting the facility name to request the information providing and the user identification information to the provision unit 4 and then obtains the information indicating the usage status of each equipment 2, whose publication level is set to be accessible with respect to the user access permission set corresponding to the user identification information, from the provision unit 4. In another case, for example, the user terminal 6 transmits the authentication information to the external provision unit 5 to request the information providing, and then obtains the information indicating the usage status of each equipment 2 that is received by the external provision unit 5 from the provision unit 4. The user terminal 6 operates by executing a specific program by a computer. More specifically, the user terminal 6 may have a computer-readable non-volatile medium for making the computer to rad a specific program so as to realize a specific function or execute specific processing defined by the specific program. In other words, in the user terminal 6, the communication function between the provision unit 4 and the external provision unit 5 and the input-output function between the user and the user terminal 6 may be realized by the software stored in the hardware of the user terminal 6. The user terminal 6 functions as an execution environment of a terminal application of the service provided by the provision unit 4 and the external provision unit 5 accessed by the user. The smart speaker used as the user terminal 6 is a computer having a voice input function, a voice output function, a communication function and the like, for example, the user terminal 6 is configured to receive the input operations by voice of the user and output the obtained information indicating the usage status of each equipment 2 by the voice and the like.

Next, an operation example of the provision unit 4 shown in FIG. 1 will be described referring to FIG. 8. If the operation shown in FIG. 8 starts, the provision unit 4 firstly detects whether there is an information providing request from the external provision unit 5 or the user terminal 6 (Step S1). In a case in which there is not the information providing request (“NO” in Step S1), the provision unit 4 detects whether there is an information providing request from the external provision unit 5 or the user terminal 6 (Step S1) again after a predetermined period. In a case in which there is the information providing request (“YES” in Step S1), the provision unit 4 refers to the user access permission setting file 14-1 shown in FIG. 5 to determine whether the user belongs to a user group (Step S2). In a case in which the user belongs to the user group (“YES” in Step S2), the provision unit 4 refers to the user access permission setting file 14-2 shown in FIG. 6 to obtain the information indicating the user access permission (Step S3).

In a case in which the user does not belong to the user group (“NO” in Step S2), or after the provision unit 4 obtaining the information indicating the user access permission in Step S3, the provision unit 4 refers to the publication level setting file 13 shown in FIG. 4 to determine whether to publish the usage status of each equipment to the user by each requested area of the facility according to the publication level and the user access permission (Step S4).

Next, the provision unit 4 provides the information indicating the usage status of each equipment 2 that can be published according to the determination result in Step S4 to the terminal of the user (external provision unit 5 or user terminal 6) in response to the detection result of the detection unit 21 (Step S5), and the provision unit 4 proceeds to return to Step S1. The provision unit 4 may provide the information indicating the usage status of the equipment 2 to a limited publication target according to the publication level and the user access permission by executing the above-described processing.

As described above, the equipment usage status publication system 100 according to the present embodiment has the storage unit 1, the setting unit 3, and the provision unit 4. The storage unit 1 is configured to store information indicating a plurality of equipment (equipment-zone correspondence file 11 and the like), each of the plurality of equipment 2 having one or more than one detection units 21 for detecting a usage status, information (equipment-zone correspondence file 11 and the like) indicating a plurality of zones where the plurality of equipment 2 are disposed respectively, information (zone-area correspondence file 12 and the like) indicating each area where each of the plurality of zones belongs, and information (user access permission setting file 14, user access permission setting file 14-1, and user access permission setting file 14-2) indicating an access permission for a user. The setting unit 3 is configured to set a publication level with respect to each area. The provision unit 4 is configured to provide information indicating the usage status of each of the plurality of equipment 2 according to the detection result of the detection unit 21 and according to the publication level and the user access permission (access permission) to a terminal of the user (external provision unit 5 and user terminal 6). According to the equipment usage status publication system 100 according to the present embodiment, it is possible to provide information indicating the usage status of the equipment such as the toilet and the like by limiting the publication target according to the user.

According to the present embodiment, the setting unit 3 may set the publication level by each area and by each type of the equipment.

The setting unit 3 may display the images indicating the correspondence relationship of the area and the zone such as the three-dimensional model image M1 (three-dimensional model), the floor map P1 and the like on the display unit 32, and set the publication level by each area in response to the input operation to the image.

The setting unit 3 may set the publication level so as to automatically change the publication level on a predetermined day or at a predetermined time. In other words, the setting unit 3 may set the publication level so as to change the publication level on weekdays and holidays or at daytime and nighttime.

The setting unit 3 may set the publication level so as to automatically change the publication level in response to a predetermined environment change. In other words, for example, the setting unit 3 may set the publication level so as to change the publication level in response to an event held at the installation position of the equipment 2 or in the vicinity of the installation position of the equipment 2, and the environment change such as an earthquake, climate disasters and the like.

The storage unit 1 may store the information indicating the user access permission by a unit formed from a plurality of users (by each user group). In other words, the storage unit 1 may store the information indicating the user access permission by each user group. The storage unit 1 may store the information indicating the user access permission by a user unit.

The information providing from the provision unit 4 to the external provision unit 5 or the user terminal 6 and the information providing from the external provision unit 6 to the user terminal 6 may be performed by the following methods. In other words, for example, by publishing the provision unit 4 and the external provision unit 5 as an application protocol interface (API), it is possible to provide the information indicating the usage status of the equipment to other general administrator and terminal users as publication information. It is easy to cooperate with an external application service such as a map information application and a navigation application by publishing the provision unit 4 and the external provision unit 5. The API may be provided to the external provision unit 5 and the user 6 via a limited communication network, or the API may be published on the web and the access to the API may be allowed with respect to the external provision unit 5 and the user 6 assigned by the building management system. According to the present embodiment, for example, in the area which is only open to limited building tenants and the area in which visitors are restricted by the security system, it is preferable to limit toilet information. In other words, for example, in areas in which visitors are restricted, the toilet information will never be completely “visible” (published). There is a case in which the building administrator considers not restricting general visitors from entering the building; however basically limits users of the toilet to be visitors having appointments in the building (called a “gray zone area”). According to the present embodiment, the building management system may set the range for open by setting the publication level of the toilet information by each area or publishing the API only to the specific system (internal service of the tenant). According to the building management system according to the present embodiment, it is possible to promote or suppress usage of equipment depending on the situation by changing the degree of the “visualization” of the toilet information with respect to the gray zone, for example. The equipment usage status publication system 100 according to the present embodiment may be adopted as an Internet of Things (IoT) based building management or town management platform in various service business.

The equipment usage status publication system 100 shown in FIG. 1 may be configured (or adopted) in the following forms, for example.

(1) In a case of a usage directly connected to the building management and the application in the user terminal 6 is managed by the building management agency, for example, the management agency may link the system with the application in the user terminal 6 of a garbage man so as to manage and confirm the cleaning status.

(2) In a case of a usage open to public view by a plurality of people in a common space in the building, the user terminal 6 may be a common terminal rather than the personal terminal of the visitor.

(3) The external provision unit 5 may be directly connected to an intracompany system rather than a service operating company so as to publish the information only to tenants on the floor or in the area, for example.

(4) In a case of publishing the information only to tenants and visitors, besides performing the identification by using the user ID, it is possible to restrict the connection to the connection network such as the intracompany local area network (LAN) or the LAN in the building.

(5) As an example of a general external provision unit 5, it is possible to provide the information to an API usage contractor (for example, a navigation application agency signing the contract).

(6) It is possible to publish the external provision unit 5 to the public as a web API and various application vendors may register to the API on the web so as to access to the toilets and the like in the public space.

The building management system 10 according to the present embodiment may be configured to set security levels by each area on the floor map and define the area (such as a private area, a public area, a security area and the like) formed from a plurality of zones. The building management system 10 according to the present embodiment may easily set the security level in response to the change of the building by setting the publication level by each area. The building management system 10 according to the present embodiment may store the boundary line as metadata of the drawing in the storage unit 33 and assign the security level by each area. The boundary line may be generated by the interface provided for the administrator to move the boundary line on the display image and the automatic measurement device in the field. The access permission to the building may be changed by automatically locking the gate and the like in response to the setting in the system. The equipment information (such as the toilets) in the same area may be listed up in the system according to the definition of the area. The equipment having a plurality of properties (such as the private room of the toilet) may be collectively treated as an equipment unit. A plurality of equipment units in the same area may be collectively treated.

According to the building management system 10 according to the present embodiment, in a case in which the information providing from the provision unit 4 to the external provision unit 5 and the information providing from the external provision unit 5 to the user terminal 6 are published as the API on the web, it is possible to issue the user ID following the same form. In other words, an individual user ID is issued to the external usage agency of the API except the provision unit 4 and the external provision unit 5. The building management system 10 according to the present embodiment forms a group (user group) formed from a plurality of user IDs and collectively assigns the same access permission to the plurality of user IDs. In this case, for example, it is possible to set the user ID or the user group who may access the equipment information API by each equipment unit (such as the toilet for men in the south on the second floor). In other words, the information provided from the provision unit 4 and the external provision unit 5 to the user terminal 6 is in a direct provided form, and the service via the API provided by the external API usage agency is in a redistribution form. For example, on the side of the API usage agency, it is easy to set the access permission again by each area with respect to the information collectively published to the API.

The building management system 10 according to the present embodiment may form a group (equipment group) from each equipment unit or each area and collectively assign the user ID and the user group with respect to the plurality of units and areas. The building management system 10 according to the present embodiment may access the equipment information via the API provided by the external API usage agency in response to the setting on the display.

According to the present embodiment, for example, it is possible to assign a publication range by the API to publish the building management information by each level. It is possible to connect the building management system 10 according to the present embodiment to a backbone information system of the town by making the systems able to connect with each other. The building management system may be connected with other building management systems under the same administration company so as to be integrally administrated. The building management system may be connected to an administrative disaster prevention system and the like. Each of the building management systems may be connected to a local backbone system configured from a plurality of building management systems in the local town. With respect to each of the building management systems and the local backbone system, for example, it is possible not only for the building management company (or local administration union) to arbitrary set the degree for publishing the toiler information, but also for connected computers (for example, by artificial intelligence) to automatically adjust the degree for publishing the toiler information. For example, in a case in which an evacuation site is set in the same town, each of the building management systems and the local backbone system may automatically open all of the toilets in the gray zone area and open the private area due to a situation according to the administration service contract (special contract). For example, at the time when a large-scale concert is conducted nearby, the toilet information in the gray zone area may be temporarily visible (published) to solve the problem of lack of toilets. For example, each of the building management system and the local backbone system may level the congestion degree of the toilets among the plurality of buildings by adjusting the publication degree with respect to the search result of the toilets so as to guide the user to the toilet nearby.

The embodiments of the invention have been described above with reference to the drawings, but specific structures of the invention are not limited to the embodiments and may include various modifications without departing from the scope of the invention. The invention is not limited to the above-mentioned embodiments and is limited only by the accompanying claims.

In the above-described embodiments, part of the program or all of the program executed by the one or several computers configuring the equipment usage status publication system 100 may be distributed via a computer-readable recording medium or communication line. The publication level may be defined by multiple values indicating different publication degrees (for example, a value “1” represents the lowest publication level, and a value “2” represents a low publication level next to the value “1”).

The “computer” disclosed in the present description may be a configuration including an operation system (OS) and hardware such as peripheral devices. In addition, it is assumed that the “computer” also includes a homepage providing environment (or a display environment) once a WWW system is used. Also, the “computer-readable recording medium” refers to a writable non-volatile memory such as a flexible disc, a magneto-optical disc, a ROM, or a flash memory, a portable medium such as a CD-ROM, or a storage device such as a hard disk build in the computer.

Furthermore, it is assumed that the “computer-readable recording medium” also includes a computer-readable recording medium that stores programs for a fixed time like a non-volatile memory (for example, a dynamic random access memory (DRAM)) inside the computer serving as a server or a client in a case where a program is transmitted through a network such as the Internet or a communication line such as a telephone line. In addition, the above-described program may be transmitted from the computer in which the program is stored in a storage device or the like to another computer through a transmission medium or by transmitted waves in the transmission medium. Here, the “transmission medium” transmitting the program refers to a medium having a function of transmitting information like a network (communication network) such as the Internet or a communication line (communication wire) such as a telephone line. In addition, the above-described program may be a program for realizing part of the above-described function. Further, the above-described program may be a so-called differential file (differential program) capable of realizing the above-described function in combination with a program which is recorded in advance in the computer.

### INDUSTRIAL APPLICABILITY

According to each embodiment described above, the present disclosure can provide an equipment usage status publication system, an equipment usage status publication method, and a program.

### REFERENCE SIGNS LIST

1 storage unit
2 equipment
3 setting unit
4 provision unit
5 external provision unit
6 user terminal
10 building management system
11 equipment-zone correspondence file
12 zone-area correspondence file
13 publication level setting file
14, 14-1, 14-2 user access permission setting file
15 equipment usage status file
21 detection unit
100 equipment usage status publication system

1. An equipment usage status publication system, comprising:
a storage unit configured to store information indicating a plurality of equipment, each of the plurality of equipment having one or more than one detection units for detecting a usage status, information indicating each of a plurality of zones where the plurality of equipment are disposed respectively, information indicating each area to which each of the plurality of zones belongs, and information indicating an access permission for a user;
a setting unit configured to set a publication level with respect to each area; and
a provision unit configured to provide information indicating the usage status of each of the plurality of equipment to a terminal of each user, the information indicating the usage status corresponding to the detection result of the detection unit and according to the publication level and the access permission.

2. The equipment usage status publication system according to claim 1, wherein the setting unit is configured to set the publication level by each area and by each type of the equipment.

3. The equipment usage status publication system according to claim 1, wherein the setting unit is configured to display an image indicating the correspondence relationship between the area and the zone and set the publication level by each area in response to the input operation to the image.

4. The equipment usage status publication system according to claim 1, wherein the setting unit is configured to automatically change the publication level on a predetermined day or at a predetermined time.

5. The equipment usage status publication system according to claim 1, wherein the setting unit is configured to automatically change the publication level in response to a predetermined environment change.

6. The equipment usage status publication system according to claim 1, wherein the storage unit is configured to store the information indicating the user access permission by a user unit formed from a plurality of users.

7. An equipment usage status publication method, comprising:
storing information indicating a plurality of equipment, each of the plurality of equipment having one or more than one detection units for detecting a usage status, information indicating a plurality of zones where the plurality of equipment are disposed respectively, information indicating each area to which each of the plurality of zones belongs, and information indicating an access permission for a user, by a storage unit;
setting a publication level with respect to each area by a setting unit; and
providing information indicating the usage status of each of the plurality of equipment to a terminal of each user, the information indicating the usage status corresponding to the detection result of the detection unit and according to the publication level and the access permission by a provision unit.

8. A computer-readable non-volatile medium storing a program executed by the computer to perform a method, wherein the method comprises:
storing information indicating a plurality of equipment, each of the plurality of equipment having one or more than one detection units for detecting a usage status, information indicating each of a plurality of zones where the plurality of equipment are disposed respectively, information indicating each area to which each of the plurality of zones belongs, and information indicating an access permission for a user, by a storage unit;
setting a publication level with respect to each area by a setting unit; and
providing information indicating the usage status of each of the plurality of equipment to a terminal of each user, the information indicating the usage status corresponding to the detection result of the detection unit and according to the publication level and the access permission by a provision unit.
